(19) United States
(12) Patent Application Publication
(10) Pub. No.: US 2008/0002214 A1
(43) Pub. Date: Jan. 3, 2008

(54) Image processing apparatus

(75) Inventor: Yangyi Xu, Tokyo (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 11/802,663

(22) Filed: May 24, 2007

(30) Foreign Application Priority Data
Jun. 28, 2006 (JP) 2006-178509

(51) Int. Cl. G06F 3/12

(52) U.S. Cl. 358/1.1

(57) ABSTRACT

An image processing apparatus that generates printing data based on input manuscript data and prints the printing data is disclosed. According to the image processing apparatus,
when assemble-printing is directed wherein two or more pages of manuscript data are to be assembled onto one sheet of printing paper,
a magnification ratio to be applied to an assemble-printing domain for printing one page of the manuscript is acquired based on the number of pages to be assemble-printed onto one sheet, the width of a margin, and the size of a printable domain, and
the printing data are generated according to the magnification ratio.

The margin includes an outer margin that is the distance to an edge of the printable domain, and an inner margin that is the distance between pages to be assembled. Each of the outer and inner margins is specified as desired using a console panel.

### BACKGROUND OF THE INVENTION

1. Field of the Invention

The present invention generally relates to an image processing apparatus, and especially relates to an image processing apparatus that is capable of providing a desired margin width between assembled pages when carrying out assemble-printing.

2. Description of the Related Art

When printed material is generated, depending on purposes, the page size may be either expanded or reduced, two or more pages may be printed on one sheet, and orientation of pages may be intermingled. While there are cases wherein pages are arranged on a sheet with a margin (as shown in FIG. 10), there are cases wherein pages are arranged without any margin (as shown in FIG. 9). Examples of conventional technologies in this relationship are described below.

Patent Reference 1 discloses an image formation apparatus that automatically recognizes images to be printed, which images are in a manuscript, assembles the images without a useless margin on a sheet of printing paper, and performs assemble-printing. According to the image formation apparatus, printing paper information is acquired and the manuscript is read. An image of the manuscript is read, recognized, and a domain to be printed is recognized from the image. Data concerning the domain and the size of the domain to be printed are stored. If there are no remaining manuscripts, a drawing position on the printing paper is determined for each image to be printed. Images to be printed are collected, arranged, assembled, and drawn on the printing paper. If there are no remaining image domains, the images are printed.

According to an image formation apparatus disclosed by Patent Reference 2, image data acquired from two or more manuscripts are assembled in one sheet of the printing paper for assemble-printing. Two or more images having different sizes are assembled with a margin on one sheet of the printing paper, the sizes are adjusted to a proper magnitude, and assemble-printing is carried out. Here, a margin domain is formed on the printing paper if desired. The magnitude of the image is adjusted so that two or more images may be arranged on the printing paper with a desired margin domain. Here, the images are arranged based on one of the corners of the printing paper so that useless space may be minimized.

[Patent Reference 1] JPA 2004-104324

[Patent reference 2] JPA 2006-0423014

### OBJECT OF THE INVENTION

However, the conventional assemble-printing methods as described above pose the following problems. If pages to be assemble-printed include only text, or if characters are gathered in a boundary of the pages to be assembled, readability of the pages is poor without a margin between the pages. Even if it is possible to provide a margin, unless the magnitude of the margin can be adjusted, assemble-printing cannot be performed in an optimal size.

### SUMMARY OF THE INVENTION

The present invention provides an image processing apparatus that substantially obviates one or more of the problems caused by the limitations and disadvantages of the related art.

According to the image processing apparatus of the present invention, the magnitude of the margin between each of the pages to be assembled onto one sheet of printing paper is adjustable so that assemble-printing of the pages is carried out in the optimal size for improved readability.

Features of embodiments of the present invention are set forth in the description that follows, and in part will become apparent from the description and the accompanying drawings, or may be learned by practice of the invention according to the teachings provided in the description. Problem solutions provided by an embodiment of the present invention may be realized and attained by an image processing apparatus particularly pointed out in the specification in such full, clear, concise, and exact terms as to enable a person having ordinary skill in the art to practice the invention.

To achieve these solutions and in accordance with an aspect of the invention, as embodied and broadly described herein, an embodiment of the invention provides an image processing apparatus as follows.

### MEANS FOR SOLVING THE PROBLEM

The image processing apparatus according to the embodiment includes

a drawing processing unit for generating printing data based on manuscript data,

an outputting unit for printing the printing data on a sheet of printing paper,

a directing unit for directing assemble-printing, that is, two or more pages of the manuscript data are printed on one sheet of the printing paper, and

a margin setting unit for setting the magnitude of a margin domain in assemble-printing. Further, the drawing processing unit includes

a magnification calculation unit for acquiring a magnification (ratio) of the manuscript data for one page to a printable domain for assemble-printing based on the number of pages to be assembled in one sheet of the printing paper, the magnitude of each margin domain, and the size of the printable domain, which magnification is calculated in response to the direction provided by the directing unit to carry out assemble-printing, and

an image data generating unit for generating image data according to the magnification that is acquired by the magnification calculation unit.

Further, the margin setting unit includes

an outer margin setting unit for setting the magnitude of an outer margin that is the distance between an edge of an assemble-printing domain and an edge of a printable domain, and

an inner margin setting unit for setting the magnitude of an inner margin that is the distance between assemble-printing domains.

Further, the magnification calculation unit includes a default magnification calculation unit for calculating a magnification using a default value of the magnitude of the margin domain when the margin domain is specified outside a predetermined range. Further, the margin setting unit includes one of a unit for setting the outer margin and the inner margin based on a numerical value that represents a length, and a unit for setting the outer margin and the inner margin with based on a ratio of the outer margin to the inner margin with reference to a predetermined value.

### EFFECTIVENESS OF INVENTION

Since the margin between the pages that are assemble-printed can be optimized as described above, readability of the assemble-printed text is improved.

### BRIEF DESCRIPTION OF THE DRAWINGS

FIG. 1 is a block diagram of an image processing apparatus according to Embodiment 1 of the present invention;

FIG. 2 is a block diagram of a drawing positioning unit of the image processing apparatus according to Embodiment 1 of the present invention;

FIG. 3 is a flowchart showing an operational flow when carrying out ordinary printing of the image processing apparatus according to Embodiment 1 of the present invention;

FIG. 4 is a flowchart showing an operational flow of drawing positioning when carrying out assemble-printing of pages of the same size according to Embodiment 1 of the present invention;

FIG. 5 is a map drawing showing a determination process of an assemble-printing domain according to Embodiment 1 of the present invention;

FIG. 6 is a map drawing showing a result of the assemble-printing domains with reference to the printable domain according to Embodiment 1 of the present invention;

FIG. 7 is a map drawing showing a result when a margin 1 and a margin 2 are specified as desired according to Embodiment 2 of the present invention;

FIG. 8 is a map drawing showing a result when a margin 1 and a margin 2 are specified by a ratio according to Embodiment 3 of the present invention;

FIG. 9 is a map drawing showing a result of assemble-printing according to the conventional method; and

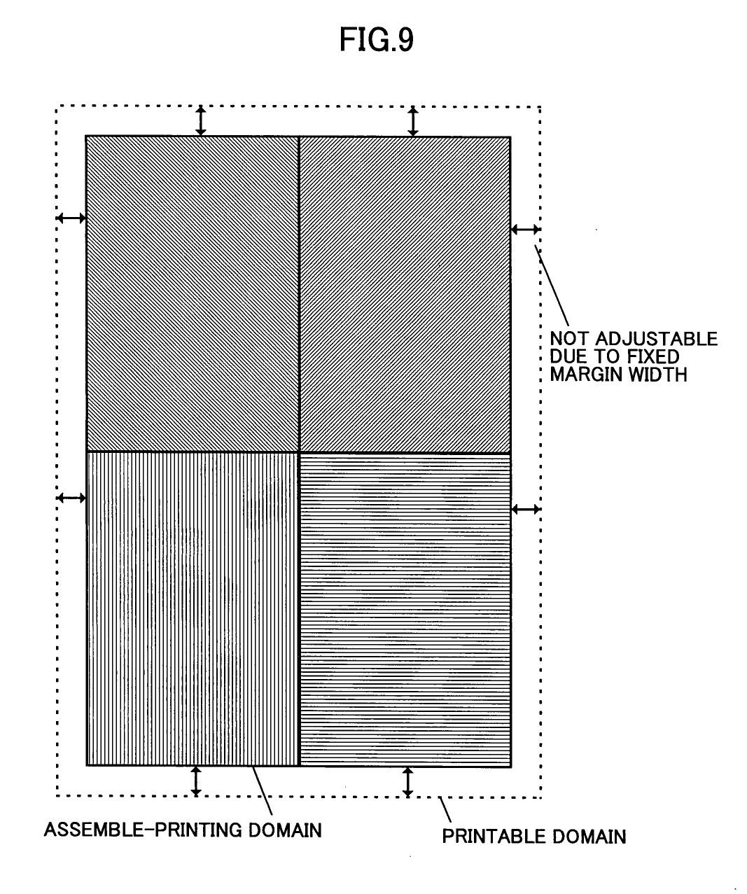

FIG. 10 is a map drawing showing another result of assemble-printing according to the conventional method.

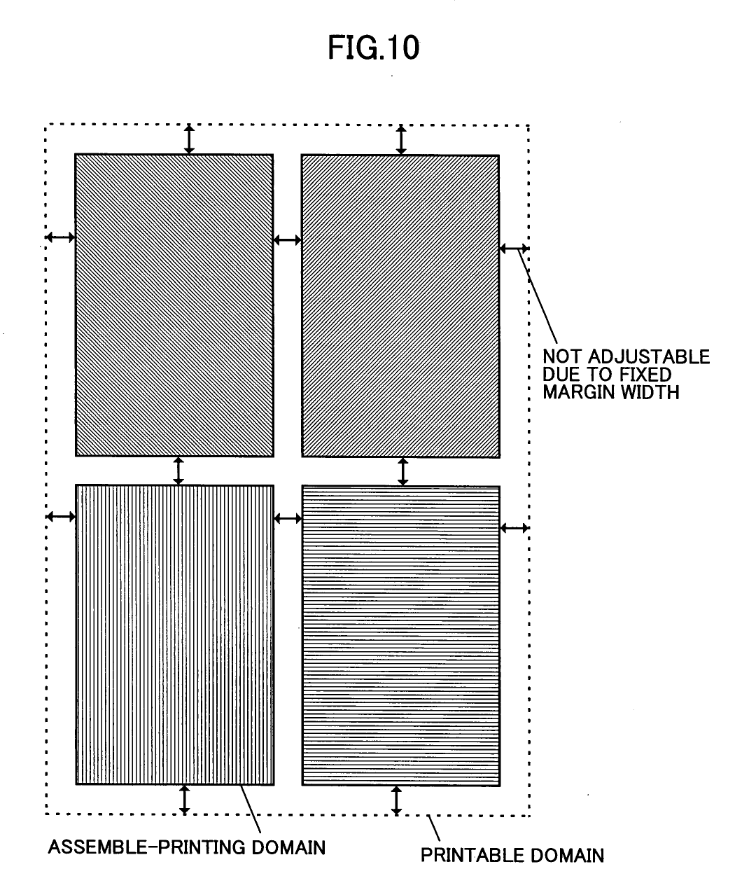

### DESCRIPTION OF THE PREFERRED EMBODIMENTS

In the following, an image processing apparatus according to Embodiments of the present invention is described with reference to the accompanying drawings.

### Embodiment 1

Embodiment 1 of the present invention provides an image processing apparatus wherein

the magnitude of a margin between pages to be assemble-printed can be set as desired,

a magnification (ratio) of a domain of one page of manuscripts to be assemble-printed to a printable domain is acquired based on the number of pages to be assemble-printed, the magnitude of the margin, and the size of the printable domain, and

printing data are generated according to the acquired magnification (ratio).

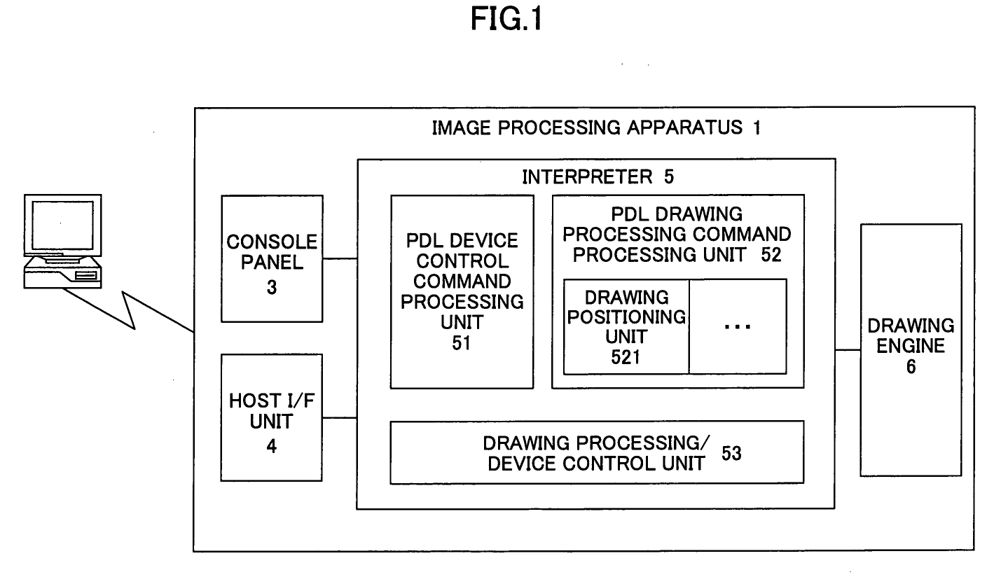

FIG. 1 is a block diagram of the image processing apparatus according to Embodiment 1 of the present invention. The image processing apparatus 1 is for generating the printing data based on manuscript data that are input, and for printing. The image processing apparatus 1 includes a console panel 3, a host I/F unit 4, an interpreter 5, and a drawing engine 6. The console panel 3 is for displaying settings of the image processing apparatus 1 and for receiving an input from a user. The host I/F unit 4 is for receiving manuscript data from a host computer. The interpreter 5 is for generating printing data based on the manuscript data according to a command. The drawing engine 6 is for printing the printing data on a sheet of printing paper.

The interpreter 5 includes a PDL (page description language) device control command processing unit 51, a PDL drawing processing command processing unit 52, and a drawing processing/device controlling unit 53. The PDL device control command processing unit 51 is for analyzing and executing a device control command. The PDL drawing processing command processing unit 52 is for analyzing and executing a drawing processing command. The drawing processing/device controlling unit 53 is for controlling a device and generating a page image to be printed in accordance with an analysis result of PDL data. The PDL drawing processing command processing unit 52 includes a drawing positioning unit 521. The drawing positioning unit 521 is for determining a drawing position.

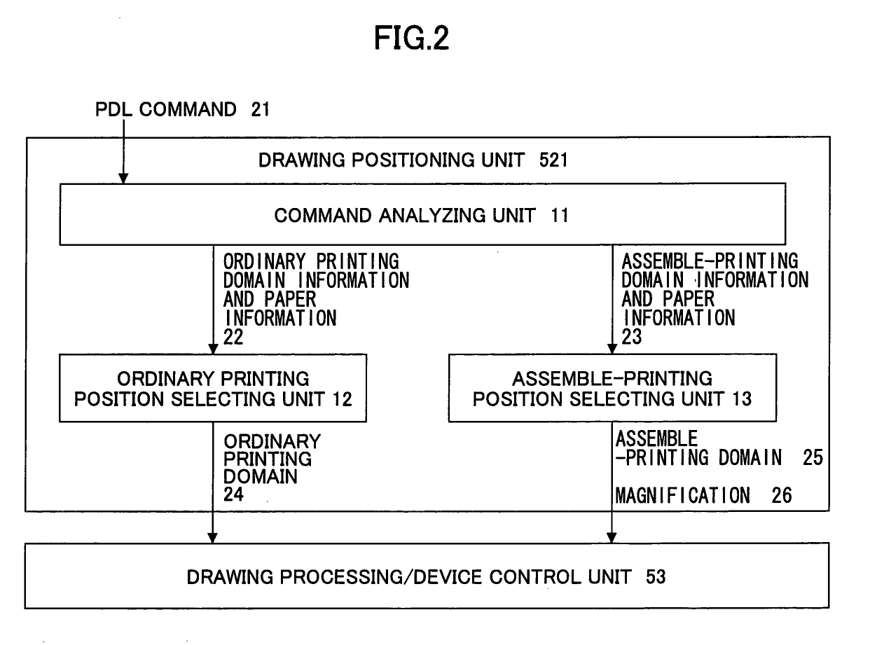

FIG. 2 is a block diagram of the drawing positioning unit 521. As shown in FIG. 2, the drawing positioning unit 521 includes a command analyzing unit 11, an ordinary printing position selecting unit 12, and an assemble-printing position selecting unit 13. The command analyzing unit 11 is for analyzing a PDL command 21. The ordinary printing position selecting unit 12 is for selecting an ordinary printing position. The assemble-printing position selecting unit 13 is for selecting assemble-printing positions and for calculating the magnification (ratio).

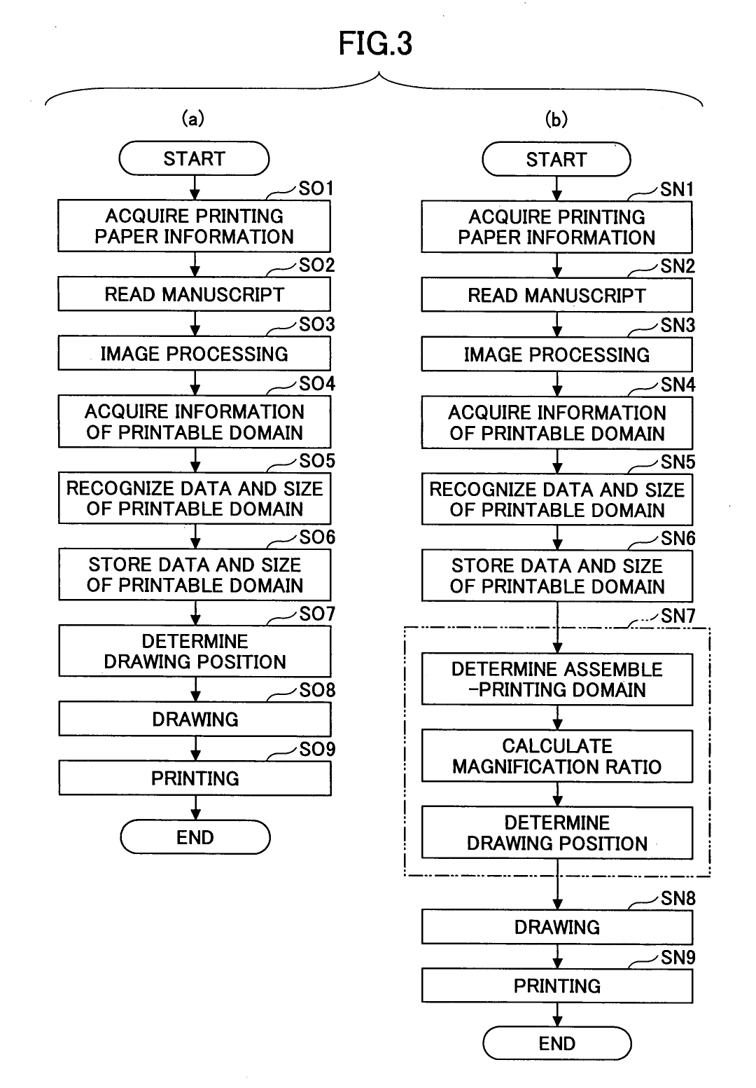

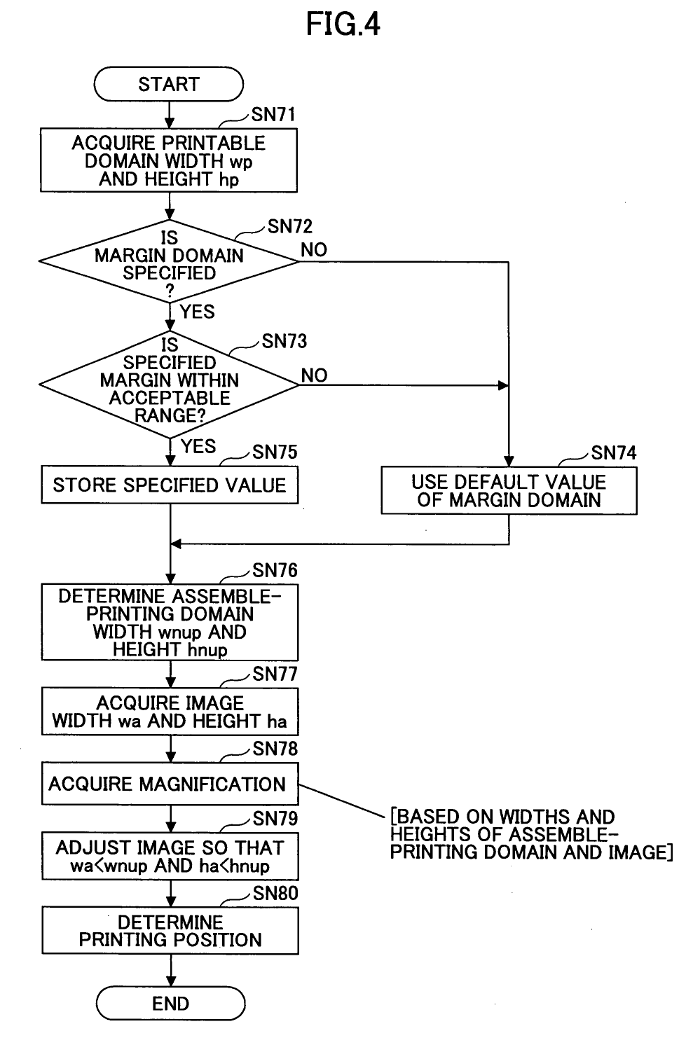

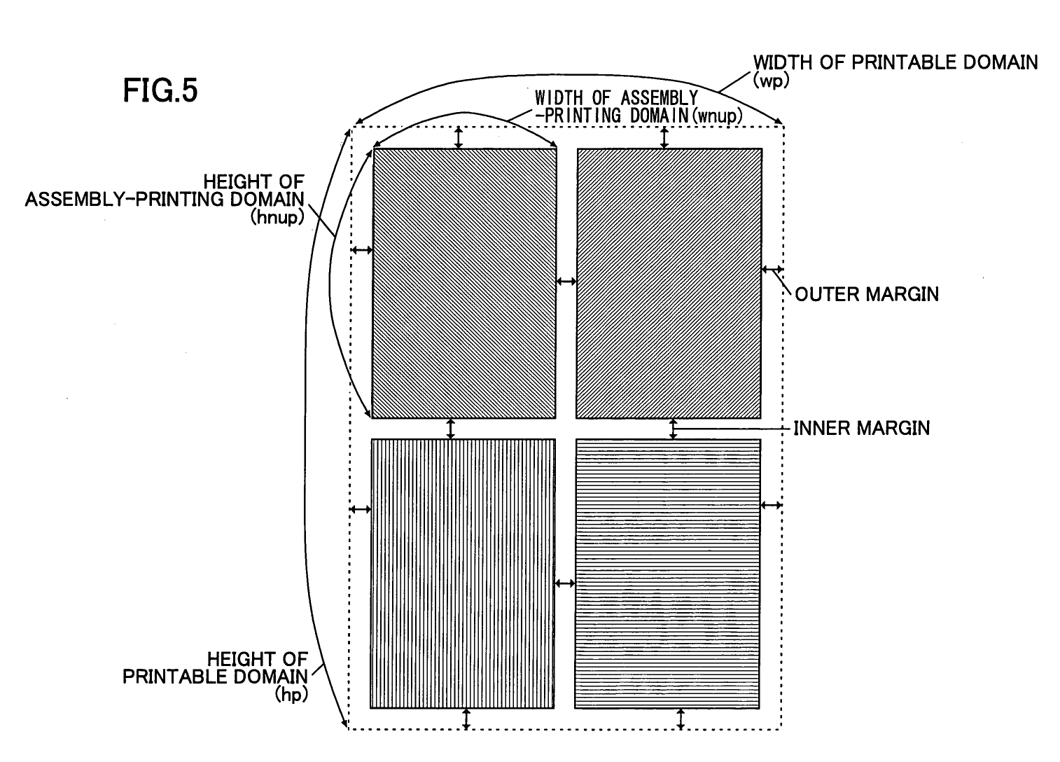

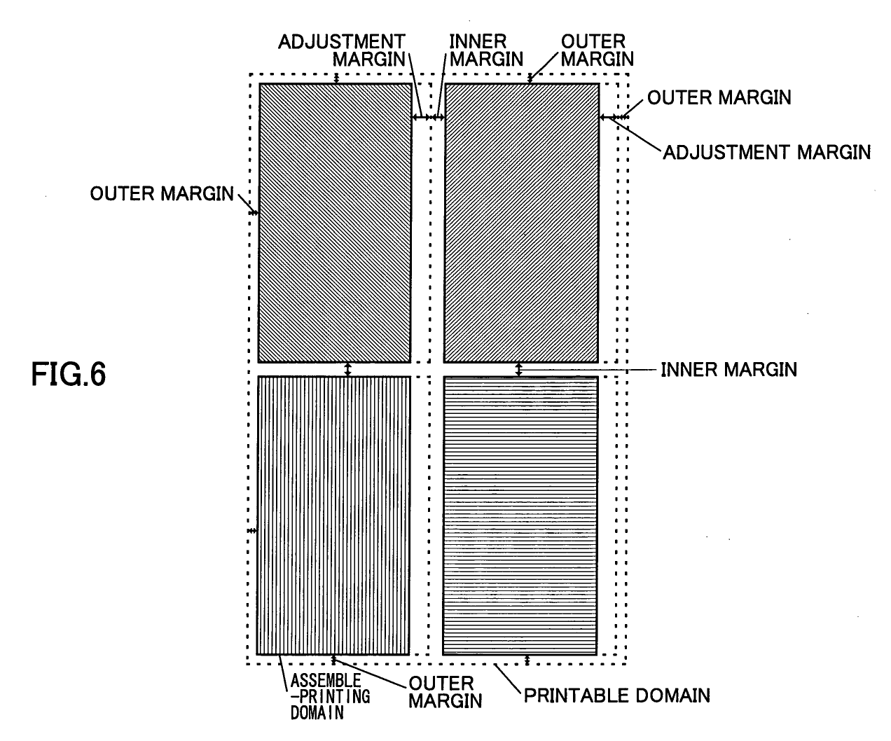

FIG. 3 is a flowchart showing an operational flow at the time of ordinary printing. FIG. 4 is a flowchart of a drawing fixing process (SN7) at the time of assemble-printing pages of the same size. FIG. 5 is a map drawing showing a determination process (SN76) of determining an assemble-printing domain. FIG. 6 is a map drawing showing a result of the determination of the assemble-printing domains with reference to the printable domain.

Functions and operations of the image processing apparatus 1 according to Embodiment 1 of the present invention configured as described above follow. First, the outline of the functions of the image processing apparatus 1 is described with reference to FIG. 1. When the user performs assemble-printing, an outer margin and an inner margin can be independently specified and adjusted. The inner margin is the distance between assemble-printing domains, each of which domains is for printing one page of the manuscript data. The outer margin is the distance between the edge of the assemble-printing domain and the edge of the printable domain of a sheet of printing paper (refer to FIG. 5, for example). The inner margin and the outer margin can be specified as desired between a predetermined range, for example, between 1 and 72 points.

The console panel 3 displays a status of the image processing apparatus 1, and receives an input from the user for changing the status. The host I/F unit 4 receives printing data from a host computer. The PDL device control command processing unit 51 analyzes and executes a device control command. The PDL drawing processing command processing unit 52 analyzes and executes a drawing processing command. The drawing processing/device control unit 53 controls a device and generation of a page image to be printed in accordance with an analysis result of PDL data. The drawing engine 6 prints the page image provided by the interpreter 5. File formats of PDL include PDF, RTIFF, and PictBridge. In the following description, Embodiments are described assuming the use of PDF; nevertheless, other formats can be used so long as the paper size can be determined at the time of interpretation.

Next, operations of the drawing positioning unit 521 are described with reference to FIG. 2. The command analyzing unit 11 receives the PDL command 21 relevant to a printing position from the PDL drawing processing command processing unit 52. The ordinary printing position selecting unit 12 receives ordinary printing domain information and paper information 22 from the command analyzing unit 11, selects an ordinary printing domain 24 from the received information. The selection of the ordinary printing domain 24 is reported to the drawing processing/device control unit 53. The assemble-printing position selecting unit 13 receives assemble-printing domain information and paper information 23 from the command analyzing unit 11. Based on the received information, an assemble-printing domain 25 is selected, and a magnification 26 is calculated based on the selected assemble-printing domain 25. The selection of the assemble-printing domain 25 and the magnification 26 are reported to the drawing processing/device control unit 53.

Next, an operational flow of ordinary printing is described with reference to steps S01 through S09 in FIG. 3. At step SO1, the information about the paper for printing is acquired from the PDL command 21. At step SO2, the PDL command 21 is interpreted and the contents of a manuscript are read. The read image of the manuscript is recognized at step SO3. At step SO4, the information about the printable domain of the printing paper is acquired from the PDL command 21. Data and size of the printable domain acquired at step SO4 are recognized at step SO5. The data and size recognized in step SO5 are stored at step SO6. At step SO7, the position at which each printing image is to be drawn on the printing paper is determined. Drawing takes place at step SO8. Printing is carried out at step SO9.

Next, an operational flow of assemble-printing is described with reference to steps SN1 through SN9 in FIG. 3. If the PDL command 21 contains an assemble-printing command wherein printing data are to be generated such that manuscript data for two or more pages are to be assembled into one sheet of the paper, steps SN1 through SN9 are carried out. At step SN1, information about the printing paper is acquired from the PDL command 21. At step SN2, the PDL command 21 is interpreted and the contents of a manuscript are read. The read image of the manuscript is recognized at step SN3. At step SN4, information about the printable domain of the printing paper is acquired from the PDL command 21. Data and size of the printable domain acquired in step SN4 are recognized at step SN5. The data and size recognized at step SN5 are stored at step SN6. At step SN7, an assemble-printing domain (domain for carrying out assemble-printing) is determined. At step SN8, a magnification for enlarging/reducing the manuscript data into printing data is calculated based on the determined assemble-printing domain. At step SN9, the drawing position of each printing image is determined using the magnification. Drawing takes place at step SN10. Printing is carried out at step SN11.

Next, the drawing position determining process (SN7) at the time of carrying out assemble-printing of pages of the same size is described with reference to FIG. 4. At step SN71, the width (wp) and the height (hp) of the printable domain are acquired from the PDL command 21. At step SN72, it is determined whether an inner margin (margin between the pages to be assembled) is specified in the PDL command 21. At step SN73, if affirmative at SN72, it is determined whether the specified margin is acceptable. If it is determined unacceptable at SN73 or negative at SN72, a default margin is used at step SN74. The default margin is, for example, 50 points. If the specified margin is acceptable, the specified margin is stored at step SN75. At step SN76, the width (wnup) and the height (hnup) of the assemble-printing domain are determined based on the magnitude of the margin and the size of the printable domain. At step SN77, the width (wa) and the height (ha) of an image are acquired. At step SN78, the magnification (ratio) of the image is acquired based on the widths and the heights of the assemble-printing domain and the image. At step SN79, arrangement of the image is adjusted so that wa<wnup and ha<hnup. The printing position is determined at step SN80.

Next, the determination process (SN76) of the assemble-printing domain is described with reference to FIG. 5 wherein four pages are assembled onto one sheet, for example. The following formula (1) calculates the width of each assemble-printing domain.

Assemble-printing domain width(wnup)=(Printable domain width(wp)−(2×outer margin width+inner margin width))/2 (1)

The following formula (2) calculates the height of each assemble-printing domain.

Assemble-printing domain height(hnup)=(Printable domain height(hp)−(2×outer margin width+inner margin width))/2 (2)

Accordingly, by changing the outer and inner margin widths of the formulas (1) and (2), the width and the height of each assemble-printing domain is changed.

An example of the assemble-printing domain under the following conditions is shown.

Printable domain width(wp)=1550 points

Printable domain height(hp)=2450 points

Inner margin width=60 points

Outer margin width=40 points

Here, “point” is a unit showing the magnitude of a type; and

1 point= 1/72 inch=25.4/72 mm≈0.35 mm

Assemble-printing domain width(wnup)=(1550−(2×40+60))/2=705 points

Assemble-printing domain height(hnup)=(2450−(2×40+60))/2=1155 points

The following formulas (3), (4), and (5) are used in the magnification determination process (SN78) for assemble-printing. Next, a method of calculating the magnification when assembling four pages onto one sheet for printing is described.

scaleX(magnification in X directions of an image)=Assemble-printing domain width(wnup)/image width(wa) (3)

scaleY(magnification in Y directions of the image)=Assemble-printing domain height(hnup)/image height(ha) (4)

scale(magnification of the image as a whole)=min (scaleX,scaleY) (5)

Here, min (scaleX and scaleY) represents the smaller one of the two scales.

An example of the magnification under the following conditions is shown.

Assemble-printing domain width(wnup)=705 points

Assemble-printing domain height(hnup)=1155 points

Image width(wa)=1223 points

Image height(ha)=2225 points

scaleX(magnification in the X directions of the image)=705/1223=0.57

scaleY(magnification in the Y directions of the image)=1155/2225=0.51

scale(magnification of the image as a whole)=min(0.57,0.51)=0.51

FIG. 6 shows a result of assembling four pages onto one sheet and using the inner margin and the outer margin in the printable domain. Here, the image is reduced so that the image height may agree with the assemble-printing domain height. That is, the assemble-printing domain width is reduced by an amount that is called an adjustment margin. Although the inner margin and the outer margin are specified by “points”, they may be specified in “mm”. Further, the margins may be specified by a magnification ratio to a default margin width. Although the inner margin and the outer margin are independently specified, the same margin width that applies to both inner and outer margins may be specified. Although Embodiment 1 is described for the case wherein four pages are assembled onto one sheet, the number of pages to be assembled is not limited to four; but rather, for example, 2 or 6 pages may be assembled onto one sheet by changing the formulas presented above according to the number of the pages.

As described above, according to the image processing apparatus of Embodiment 1 of the present invention,

the inner margin between pages to be assembled can be specified as desired,

the magnification (ratio) of the domain for the pages to be assembled onto one sheet to the printable domain is determined based on the number of pages to be assembled, the margin width, and the size of the printable domain, and

the printing data are generated according to the determined magnification. In this way, the pages can be printed with an optimal space to improve the readability.

### Embodiment 2

According to the image processing apparatus of Embodiment 2 of the present invention, the inner margin and the outer margin can be specified in vertical directions and horizontal directions.

The configuration of the image processing apparatus of Embodiment 2 is basically the same as Embodiment 1. Differences are related to where the inner margin and the outer margin are specified. When assemble-printing, the inner margin and the outer margin are specified in the vertical directions and the horizontal direction. For example, when four pages are assembled onto one sheet, the following values are specified.

Printable domain width (wp)=1550 points

Printable domain height (hp)=2450 points

Vertical inner margin=50 points

Horizontal inner margin=35 points

Vertical outer margin=30 points

Horizontal outer margin=20 points

Image width (wa)=1223 points

Image height (ha)=2225 points

In this case, the values of the formula (1) and the formula (2) are as follows.

Assemble-printing domain width(wnup)=(1550−(2×35)(+20))/2=730 points

Assemble-printing domain height(hnup)=(2450−(2×50)(+30))/2=1160 points

The magnification is calculated using the formula (3), the formula (4), and the formula (5) as follows.

scaleX(magnification of image in X directions)=730/1223=0.59

scaleY(magnification of image in Y directions)=1160/2225=0.52

scale(magnification of the image as a whole)=min(0.59,0.52)=0.52

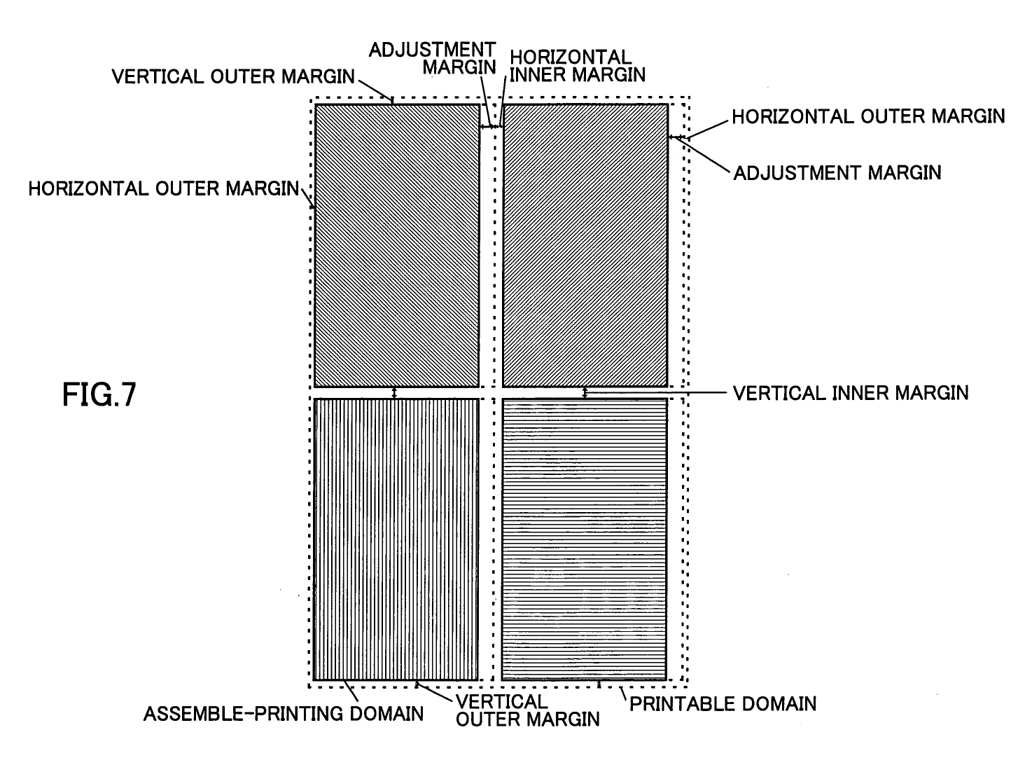

FIG. 7 shows a result when the inner margin and the outer margin are independently specified in the vertical directions and the horizontal directions. Although the inner margin and the outer margin are specified by “points”, they may be specified in “mm”. Further, the margins may be specified by a magnification ratio to be applied to a default margin width. Here, the image height is reduced to agree with the assemble-printing domain height, accordingly, the assemble-printing domain width is reduced by the adjustment margin.

As described above, according to the image processing apparatus of Embodiment 2 of the present invention, the inner margin and the outer margin are separately specified in the vertical directions and the horizontal directions. For this reason, the readability of the pages assembled onto one sheet is improved.

### Embodiment 3

According to the image processing apparatus of Embodiment 3 of the present invention, the margin is adjusted based on a ratio of the inner margin to the outer margin.

The configuration of the image processing apparatus of Embodiment 3 is basically the same as Embodiment 1. Differences are related to where the inner margin and the outer margin are specified.

When assemble-printing, the ratio of the inner margin to the outer margin is input by the user. For example, when four pages are assembled into one sheet, the following values are specified.

Printable domain width (wp)=1550 points

Printable domain height (hp)=2450 points

Image width (wa)=1323 points

Image height (ha)=2225 points

Ratio of inner margin/outer margin=3/1

First, calculations are made assuming that there is no margin to acquire a tentative adjustment margin.

Assemble-printing domain width(wnup)=1550/2=775 points

Assemble-printing domain height(hnup)=2450/2=1225 points

scaleX(magnification of image in X directions)=775/1323≈0.58

scaleY(magnification of image in Y directions)=1225/2225≈0.55

scale(magnification of the image as a whole)=min(0.58,0.55)=0.55

Since the magnification in the Y directions is adopted, the tentative adjustment margin in the X directions is as follows.

Tentative adjustment margin=775−1323×0.55≈47

Recalculations are made using the tentative adjustment margin.

Assemble-printing domain width(wnup)=(1550−235)/2=657.5 points

Assemble-printing domain height(hnup)=(2450−235)/2=1107.5 points

scaleX(magnification of image in X directions)=520/1323≈0.49

scaleY(magnification of image in Y directions)=1107.5/2225≈0.49

scale(magnification of the image as a whole)=min(0.49,0.49)=0.49

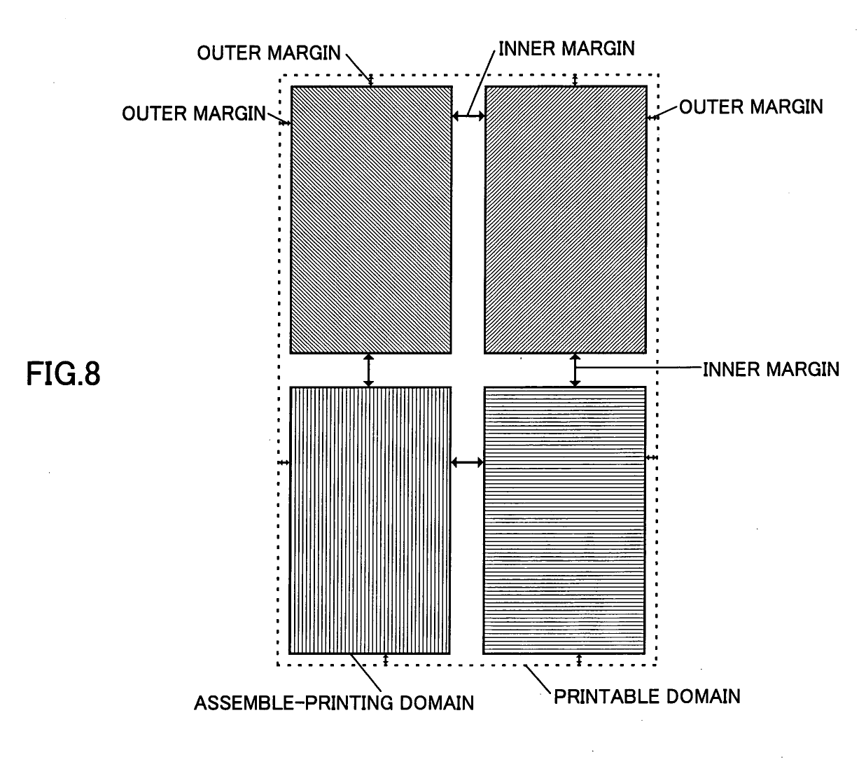

By calculating the margin based on the tentative adjustment margin and the specified ratio, the margins are adjusted to give a ratio close to the specified ratio. FIG. 8 shows a result when the inner margin and the outer margin are determined in this way. If the tentative adjustment margin is outside an acceptable range, a default value is used.

As described above, according to the image processing apparatus of Embodiment 3 of the present invention, the margins are determined based on the ratio of the inner margin to the outer margin. For this reason, the readability of the pages assembled onto one sheet is improved.

### AVAILABILITY ON INDUSTRY

The image processing apparatus of the present invention is suitable for an apparatus that offers assemble-printing.

Further, the present invention is not limited to these embodiments, but variations and modifications may be made without departing from the scope of the present invention.

The present application is based on Japanese Priority Application No. 2006-178509 filed on Jun. 28, 2006 with the Japanese Patent Office, the entire contents of which are hereby incorporated by reference.

What is claimed is:

1. An image processing apparatus including a drawing processing unit for generating printing data based on manuscript data that are input, and an outputting unit for printing the printing data on a sheet of printing paper, comprising:
a directing unit for directing assemble-printing wherein the manuscript data for a plurality of pages are printed on one sheet of the printing paper; and
a margin setting unit for setting a width of a margin domain in the assemble-printing; wherein
the drawing processing unit includes
a magnification calculation unit for acquiring a magnification ratio of an assemble-printing domain for printing the manuscript data for one page to a printable domain in response to the direction of the assemble-printing based on the number of pages to be assembled on one sheet of the printing paper, the width of the margin domain, and a size of the printable domain; and
an image data generating unit for generating image data according to the acquired magnification ratio.

2. The image processing apparatus as claimed in claim 1, wherein the margin setting unit comprises:
an outer margin setting unit for setting an outer margin that is a margin domain equal to a distance between an edge of the assemble-printing domain and an edge of the printable domain; and
an inner margin setting unit for setting a margin width between assemble-printing domains.

3. The image processing apparatus as claimed in claim 1, wherein the magnification calculation unit acquires the magnification ratio using a default value of the magnitude of the margin domain, if the magnitude of the margin domain that is specified is outside of a predetermined range.

4. The image processing apparatus as claimed in claim 2, wherein the margin setting unit comprises:
a unit for setting the inner margin and the outer margin by a numerical value.

5. The image processing apparatus as claimed in claim 2, wherein the margin setting unit comprises:
a unit for setting a ratio of the outer margin to the inner margin.

6. An image processing method wherein printing data are generated based on manuscript data that are input, and the printing data are printed on a sheet of printing paper, the image processing method comprising:
a step of acquiring a magnification ratio of an assemble-printing domain for printing the manuscript data onto one sheet to a printable domain based on the number of pages of manuscript data to be assemble-printed, a width of a margin domain in the assemble-printing, and a size of the printable domain in response to directions of assemble-printing wherein a plurality of pages are assembled into one sheet of printing paper, and
a step of generating the printing data according to the acquired magnification ratio.

7. The image processing method as claimed in claim 6, wherein an outer margin between an edge of the assemble-printing domain and an edge of the printable domain is specified, and an inner margin between assemble-printing domains is specified.

8. The image processing method as claimed in claim 6, wherein the magnification ratio is acquired using a default value of the margin domain if the margin domain specified is outside of a predetermined range.

9. The image processing method as claimed in claim 7, wherein the outer margin and the inner margin are specified by a numerical value.

10. The image processing method as claimed in claim 7, wherein the magnitude of the margin domain is determined by a ratio of the outer margin to the inner margin.

11. A computer program for a computer to carry out the image processing method as claimed in claim 6.

12. A recording medium that stores the computer program as claimed in claim 11.
